(19) United States
(12) Patent Application Publication
(10) Pub. No.: US 2014/0297418 A1
(43) Pub. Date: Oct. 2, 2014

(54) DELIVER PASSENGER CENTRIC ADVERTISEMENTS TO IN-FLIGHT ENTERTAINMENT SYSTEM USING AUCTION BASED EXCHANGE

(71) Applicant: Vivek Gaur, Dublin, CA (US)

(72) Inventor: Vivek Gaur, Dublin, CA (US)

(21) Appl. No.: 13/851,957

(22) Filed: Mar. 28, 2013

(51) Int. Cl. G06Q 30/02

(52) U.S. Cl. CPC G06Q 30/0269; G06Q 30/0265
USPC 705/14.62

(57) ABSTRACT

A system and method for delivering passenger-centric advertisements to in-flight entertainment systems using auction based exchange. An interface is provided for the airlines to provide the passenger profile data. Another interface is provided for the advertisers to bid on passenger profile data using an auction. A winning bid is selected from plurality of bids, and the relevant ads are placed in the media stream consumed by the specific passenger. A method is provided to insert ads in passenger media streams using an AD exchange client. A method is provided to send back the passenger interaction data and billing information to the advertisers.

### RELATED APPLICATIONS

Not applicable.

### FEDERALLY SPONSORED RESEARCH

Not Applicable.

### SEQUENCE LISTING

Not Applicable.

### BACKGROUND OF THE INVENTION

The present invention relates generally to advertising and, more particularly, for delivering relevant advertisements by matching advertisers targeting criteria to the aircraft passenger profiles through an in-flight entertainment system.

The field of TV advertising has changed a lot since the introduction of digital video recording devices. Now, audiences have the option of recording the shows and skip through the commercials. This trend is leading to diminishing effectiveness of TV commercials. Also, another threat to TV advertising is on-demand video services. TV advertisements also cannot be targeted for each viewer like internet advertising. Even with detailed demographic studies regarding their viewers, most of the ad budget fails to create and impact with the targeted viewers. Also, there is a lack of feedback mechanism from the audience back to the advertisers. The method of dynamically serving in-steam ads for audio and video content has been disclosed in U.S. Pat. No. 6,950,623.

The Internet advertising is another way for advertisers to reach their audience. However, it has the disadvantages of lack of engagement from the audience. Also, it lacks the rich-media delivery capabilities like a TV ad for making a high impact. In most cases, the ads shown are targeted to the content of the web page rather than the users. The method for serving relevant advertisements based on webpage content has been disclosed in U.S. Pat. No. 7,716,161. The users are also having ad-fatigue and are not satisfied with irrelevant ads and products. An auction based approach for internet advertising was disclosed in Pub. No. US 2008/0262917.

Currently, there is a huge effort on part of airlines to provide their passengers with the latest in-flight entertainment systems. The investment in in-flight entertainment has huge returns in terms of enhanced passenger experience. The delivery of weather information to passengers through aircraft in-flight entertainment system has been discussed in U.S. Pat. No. 7,587,733 and Pub. No. US 2003/0229897. In these prior works, the advertisements matched to passenger profile require live or satellite TV. Also, it requires at least one separate passenger advertisement channel. These works also required to monitor at least one flight parameters like geographical location. The delivering of tailored advertisements is disclosed as part of U.S. Pat. No. 6,810,527.

Although these patents disclose systems capable of delivering tailored content and advertisements to the passengers, the prior art is deficient in certain key features. First, lacking is the passenger-centric and media-independent approach. The advertisements delivered are targeted based on whole aircraft or cabin-class features. Second, the system disclosed lacks the auction based approach for advertisers. Advertisers cannot target the messages depending on demographics of each passenger. The auction based approach maximizes the revenue for the airlines. Third, the advertisements have to be multiplexed with the content in advance. This lacks the real-time insertion of ads in the media or data stream used by the passenger. This severely limits the ad delivery capability. Fourth, this approach only supports video ads to be delivered. This does not support display, banner, text or audio ads. Fifth, there is no mechanism for delivering the user feedback data back to advertisers. The only information advertisers get is the number of advertisement impressions shown. Finally, in some cases a separate channel or live TV is required for advertising. This limits the effectiveness of the approach.

It will therefore be useful to deliver passenger-centric media-independent ads based on passenger demographics. Advertisers can bid on the passenger profiles they want to target, in turn maximizing the revenue generated to the airlines. Advertisers can also get feedback data like passenger contact information in case they want more information regarding the service or product shown.

### BRIEF SUMMARY OF THE INVENTION

The present invention describes an enhanced system and method for delivering passenger-centric ads to in-flight entertainment system using an auction based exchange.

In one aspect, an airline interface is provided for allowing the airlines to input the passenger profile data for multiple flights. Another interface is provided for advertisers to configure and launch ad campaigns and also to place bid on targeted profiles. The winning bids are automatically selected and corresponding ads are selected to be inserted in the passenger media streams.

In another aspect, the ad exchange client system inserts real-time ads in passenger media stream by switching between the ads streams and the media content. The client system also collects the user-feedback data and communicates it back to the advertisers.

The current invention enables the advertisers to create highly efficient and effective ad campaigns to target the precise audience. The advertisers can get real-time metrics to control the ad campaign better and to uplift brand awareness. The present invention also enables the airlines to control the price, frequency and quality of ads shown to their passengers. The airlines may use the auction based exchange to maximize their revenue. The passengers are more satisfied because they see more relevance and value in the ads that they are shown.

This summary is provided to introduce a selection of concepts in a simplified form that are further described below in detailed description. This summary is not intended to identify key features or essential features of the claimed subject matter, nor is it intended to be used as an aid in the determining the scope of claimed subject matter.

### BRIEF DESCRIPTION OF THE DRAWINGS

FIG. 1 is a block diagram of an environment suitable for use in implementing the present invention.

FIG. 2 is a block diagram of an embodiment of ad exchange server and various interfaces and components it embodies.

FIG. 3 is an overview of the components of ad exchange client to insert real time ads and transmit the user feedback back to advertisers.

### DETAILED DESCRIPTION

The subject matter of the present invention is described with the specificity to meet the statutory requirements. However, the description itself is not intended to limit the scope of this patent. The claimed subject matter might also be used in other ways, to include different steps or combination of steps similar to the ones described in this document, in conjunction with other present or future technologies.

The present invention provides a real-time, auction-based exchange for delivering passenger-centric ads through the in-flight entertainment systems. The invention may be described in the general context of computer-executable instructions being executed by a computer. Generally, these instructions are in form of modules which include routines, programs, objects, components, data structures etc. that perform a particular task. Moreover, those skilled in the art will appreciate that the invention may be practiced with a variety of computer-system configurations, including handheld and wireless devices.

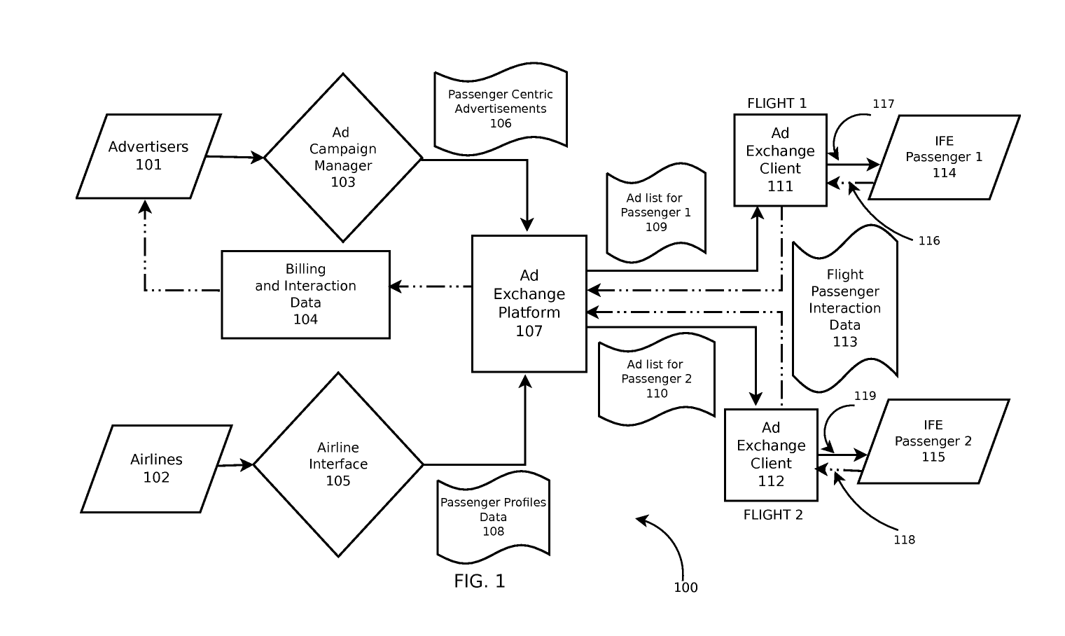

FIG. 1 illustrates a system 100 which represents an exemplary environment in which the present invention may be practiced. The system 100 includes advertisers 101. The advertisers may be any entities interested in placing the content in the in-flight media, including entities seeking to insert content for the purpose of advertising.

The system 100 further includes airlines 102. The airlines are the entities operating certain number of aircrafts. The current invention can also be applied to other types of moving vehicles in an alternate embodiment like high-speed trains or cruise ships.

An ad campaign manager 103 is also included in the system 100. The ad campaign manager provides an interface for the advertisers 101 to search and bid at relevant profile data provided by the airlines 102. Any communication relationship is acceptable for use with advertisers 101 and ad campaign manager 103. The ad campaign manager can be used to create new campaigns and provide passenger-centric advertisements 106. Further an ad campaign can focus on a single product line or many product lines together.

An airline interface 105 is also provided in the system 100. The airline interface 105 allows airlines 102 to provide the passenger profile data 108 for searching and bidding by the advertisers 101 using the ad campaign manager 103. Any communication relationship is acceptable for use with airlines 102 and the airline interface 105.

The system 100 also includes an ad exchange platform 107. The ad exchange platform provides a marketplace to bring the advertisers 101 and airlines 102 together. The ad exchange platform provides an auction based environment. In other embodiment, the ad exchange platform can provide an interface to advertisers 101 to handle the rule-based bidding. In rule-based bidding, the advertisers 101 can set the profile attributes to bid on in advance. These rule-based bids can be automatically resolved by the ad exchange platform. The rule-based bids let advertisers to carefully screen and select each ad impression.

The ad exchange platform 107 may automatically generate the ad list 109 for passenger 1 114 and ad list 110 for a passenger 2 115 on-board flight 1 and 2 respectively. The ad lists 109 and 110 might be in the form of a single compressed file or several video or audio files.

The system 100 also includes an ad exchange client 111 on-board flight 1 and 112 on-board flight 2. In one embodiment, the ad exchange clients 111 and 112 may be a computer program running on the main computer hardware of the aircraft. Those skilled in the art will appreciate that any number of configurations may be appropriate for ad exchange clients 111 and 112. The ad exchange clients 111 and 112 can communicate with the ad exchange platform 107 to receive the ad lists 109 and 110. As will be discussed later, the ad exchange client 112 might multiplex the ads in the ad lists 109 and 110 with the on-demand media 117 and 119 being consumed by the aircraft passengers 114 and 115. The on-demand media 117 and 119 may contain video, audio, internet content or games. Any communication relationship is allowed between the ad exchange platform and the ad exchange clients.

The ad exchange clients 111 and 112 may also be able to collect the passenger 114 and passenger 115 interactions, feedback and other information related to the ad shown in the form of interaction data 116 and 118. The ad interaction data 116 and 118 might be in the form of request for more information regarding the product or contact information provided by passengers 114 and 115. The ad interaction data 116 and 118 might also include the impressions of the ad actually shown to a passenger 114 and 115. As will be understood by those skilled in art, ad analytics might contain any information regarding the passenger 114 and passenger 115 interactions with the particular advertisement.

The ad exchange clients 111 and 112 may also communicate the ad interaction data in consolidated form 113 to the ad exchange platform 107 at the end of the flight or during the flight. The ad exchange platform 107 may collect the ad analytics from various ad exchange clients 111 and 112 on-board many aircrafts and generate a detailed billing and interaction information 104 for the advertisers 101. The billing might be based on pre-selected attributes like price per impression. This report 104 may also be used to provide helpful feedback to the advertisers regarding their ads or products shown in the ads.

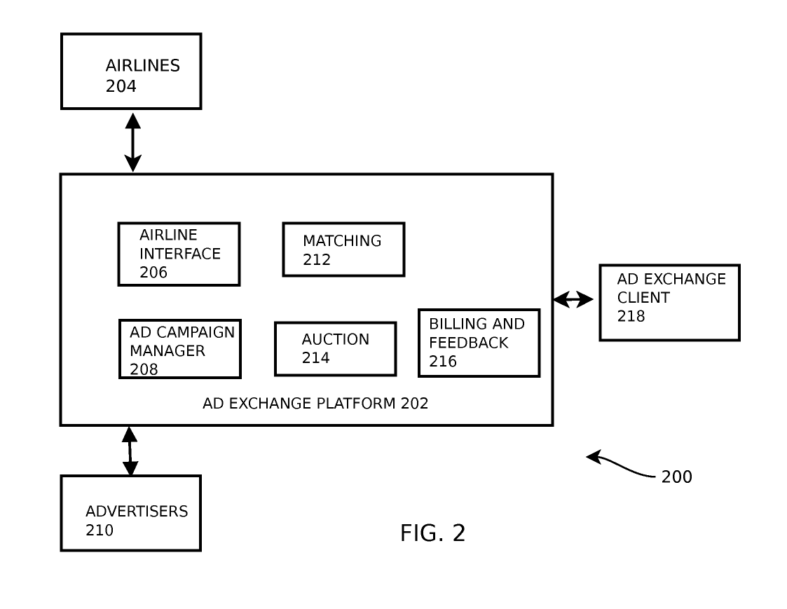

In FIG. 2 illustrates the system 200 which represents one embodiment of ad exchange platform 202. The system 200 includes airlines 204 and advertisers 210. Similar to the airlines 102 and advertisers 101 of FIG. 1, the airlines 204 are the entities operating certain number of aircrafts, while the advertisers 210 may be any entities interested in placing content in the media. The ad exchange platform can be implemented using various configurations of computer hardware and software.

The system 200 consists of an airline interface module 206. The airline interface module 206 permits the airlines to provide the passenger profile data to the ad exchange platform 202. A profile may be the information regarding passenger demographics, location (origin and destination), cabin class, seating assignment, etc. There may be checks implemented to filter out the personally identifiable information like social security number or name. The airline interface may be developed in modular form, where new information can be added if needed. The airline interface module may also have filtering mechanism to make particular profiles available to only particular advertisers. The airline interface 206 may allow the airlines to input the number of ads to be shown per passenger, minimum price and ad quality. This may enable airlines to maximize yields for their passenger profile inventories. This may also enable airlines to control the passenger experience.

The system 200 further includes an ad campaign manager 208. The ad campaign manager allows the advertisers to search the passenger profile data and tailor their advertisements. The ad campaign manager provides advertisers a complete control to launch campaigns according to budget, timeframe, pacing and frequency capping and passenger demographics.

The interface may have the modular targeting capabilities, so individual targeting methods can be added under the categories of targeting. This takes advantage of capabilities of the ad exchange platform to achieve highly targeted advertising.

The ad campaign manager may provide the following capabilities:
Create one or more advertising campaigns.
Choose the type of ad creative: Video, Audio or Banner text.
Create or search a list of targeted passenger profiles for each campaign.
Allocate the budget for each campaign.

In one embodiment, the advertisers may choose for the following targeting categories:
Contextual: Related to the content or media being consumed by the passenger.
Demographic: Age, Gender, etc.
Time Zones and Space: Geographical location or time zones.
Time into the flight: To identify when passengers are more alert depending on the time into the flight.
Advertisement frequency: ad frequency for each campaign or flight.
Frequency caps: ad frequency for each targeted passenger.
Airlines: select airlines for the campaign. For example, advertisers might want to exclude budget airlines from luxury ad campaigns.
Seating class: first class, business class or economy class.
Ad Creative type: display, video, banner, audio, pre-roll, in-banner videos and in-stream video ads.
Ad Content rating: ad content rating to check if certain ads are suitable for some demographics or not.

For example, an advertiser for video games can choose to show a banner ad for 18-30 year old male passengers as their primary audience. They can also choose to show a video ad for their secondary target audience of 30-35 year old females. By using, the ad exchange platform advertisers may target their ads to the precise audience for their product or services. The advertisers may create different ads for the same product targeting various target profiles. This may increase the impact and effectiveness of the ads.

The system 200 further includes the matching module 212. The matching module may generate an automatic list of advertisement based on the targeting criteria of 208 and the passenger profile data 206. The matching module may take the inputs from the advertiser interface, auction module and airline interface. The matching module 212, in one embodiment may be implemented as intelligent computer program to analyze all the inputs and generate an ad list to maximize the revenue for the airlines and to maximize the impact and effectiveness of each ad campaign. For example, the matching module might generate a sequence of ads for a new car model followed by car insurance ads to maximize the impact of the ads. In another example, the matching module can generate a list of ads showing various products or services from the same company to build brand awareness and value.

The system 200 further includes the auction module 214. The auction module 214 interacts with the advertiser interface 208, airlines interface 206 and the matching module 212. The auction module may conduct the rule-based auction, real-time auction or other type of auction for the passenger profile data provided by the airlines. The advertiser may choose to bid to show interest in placing the ads in the media used by targeted passengers. The rule-based auction may enable the advertisers to bid on passenger profiles using pre-defined rules. The real-time auction may enable the advertisers to bid using some increments up to some specific maximum amount. For example, an advertiser may bid $0.01 for banner ad, $0.02 for an audio ad and $0.05 for a video impression for 35 years old male passengers and also bid $0.02 for banner ad, $0.04 for an audio ad and $0.10 for 30 year old female passengers. An advertiser can also specify the maximum budget for each flight.

The billing and feedback module 216 helps performing the billing related functions. This module also may aggregate the feedback and interaction data from various ad platform clients and create the reports for the advertisers 204. For example, the billing and feedback module 216 may generate the invoices based on the ad impressions for a particular advertiser. The billing and feedback module 216 may also generate the interaction feedback for a particular advertiser based on the input provided by the passengers. This can provide a vital understanding about how users engage with their ads. For example, a passenger might provide an email address to receive more information regarding the product or service shown in the advertisement.

The feedback information, in one embodiment, might also consist of distribution of passenger demographics and total ad expressions shown. The feedback information is communicated back to the advertiser 204. Any mode of communication is allowed between the billing and feedback module 216 and advertisers 204.

The ad exchange client 218 similar to 111 and 112 of FIG. 1, as will be explained later, communicates with the ad exchange platform 200. The ad exchange client 218 receives the list of relevant advertisements for each passenger and communicates the feedback data for the ads shown.

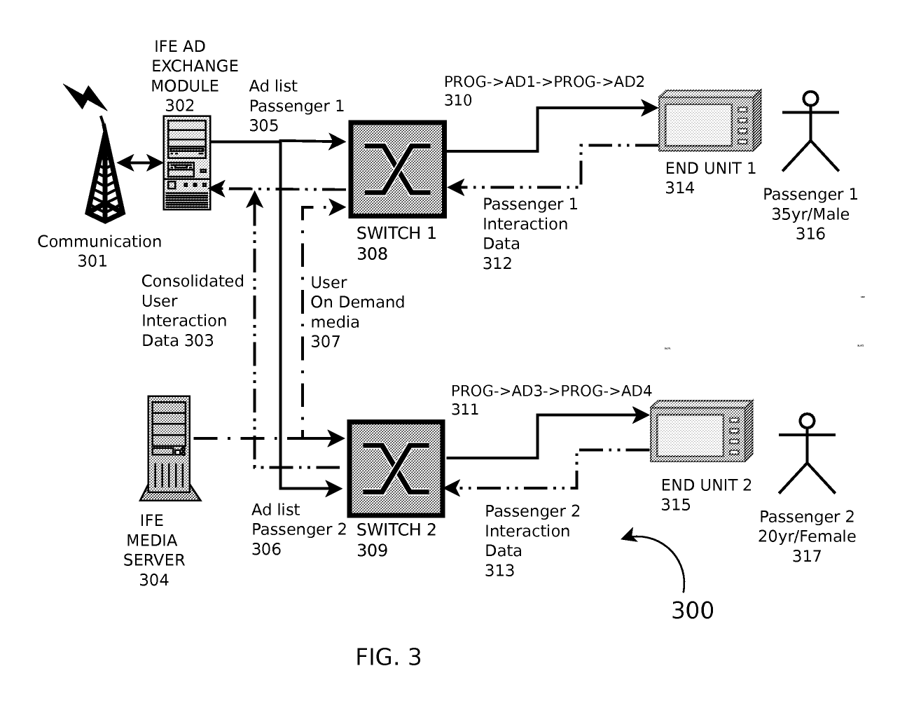

FIG. 3 is a diagram functionally illustrating an ad exchange client system 300, consistent with the invention. The ad exchange client system 300 resides on-board the aircraft. The ad exchange client system 300 is similar to 218 of FIG. 2. Those skilled in art will appreciate that many other implementations and configurations are possible, consistent with the ad exchange client system 300. The ad exchange client system 300 may work with the existing In-flight entertainment (IFE) systems.

The system 300 includes a communication component 301. The communication component 301 may communicate with the ad exchange platform 200 of FIG.2. The communication may occur using a wireless or wired connection. The communication may occur once the aircraft has landed or still in the air. This might depend on the regulations regarding the aircraft communications. The communication data may consist of list of relevant advertisements and passenger feedback data for those ads.

The system 300 further includes an IFE Ad exchange module 302. The IFE Ad exchange module 302 may process the list of relevant ads received from the ad exchange platform 200 and create an ad list 305 for passenger 1 316 and ad list 306 for passenger 2 317. The IFE Ad exchange module 302, in one embodiment may be implemented as an independent server or computer program. The IFE ad exchange module 302, in another embodiment, may also be integrated with the existing In-flight entertainment systems. The IFE ad exchange module may have the capability of serving all types of ad creatives.

The IFE media server 304 represents the in-flight entertainment file server that handles all the media related functions for a particular in-flight entertainment system. The main task of the IFE media server 304 is to deliver on-demand media to the passengers using the in-flight entertainment system. The user on-demand media 307 may include music, movies, games and internet. For example, passenger 1 316 might be watching an on-demand movie available through the IFE system while the passenger 2 317 might be checking emails or surfing the web using the IFE system.

The system 300 also includes switch modules 308 and 309. The switch modules 308 and 309, take the on-demand media content 307 from IFE media server 304 and advertisements from IFE ad exchange module 302 as inputs. The switch modules 308 and 309 may be programmed to multiplex the on-demand media being consumed by the passenger at pre-determined intervals with the ads streaming from the IFE ad exchange module 302. The switch modules 308 and 309 may also be capable of showing overlay banner ads on top of the on-demand media 307. The switch modules 308 provides a multiplexed media stream 310 which contains both on-demand media and relevant ads for passenger 1 316. Similarly, the switch modules 309 provides a multiplexed media stream 311 which contains both on-demand media and relevant ads for passenger 2 317. The switch modules 308 and 309 may be implemented as a separate hardware or software component for each passenger seat. In other embodiment, the switch modules 308 and 309, may be implemented as a centralized hardware or software component which servers all the passengers through the IFE system.

The system 300 further includes end-unit modules 314 and 315. Each of the end-unit modules 314 and 315 consists of a screen, audio outputs and hardware to drive the screen and the audio outputs. The screen can be attached to the front seat or to the in-arm of the current seat. The screen of the end-unit modules 314 and 315 may also have touch screen features. User can navigate the menus or input using touch screen gestures or through an attached input device. In one embodiment of the end-units 314 and 315, mobile computing devices also can be used. With the increasing popularity of smart phones and tablet computers, they are becoming increasing viable candidates to replace the existing IFE end-units modules 314 and 315. In some IFE configurations, each seat has its own end-unit module and switch module to provide individual passenger on-demand media 307. The end-unit modules 314 and 315 might record the data regarding passenger interaction with the ads. For example, passenger after watching ads might want some more information regarding the product or services depicted in the ads. In another aspect, the advertisers can create ads tailored for a particular passenger in form of a game. The user interaction data 312 generated for passenger 1 316 is collected by the end-unit module 314 and communicated back to the switch module 308. Similarly, the user interaction data 313 generated for passenger 2 317 is collected by the end-unit module 315 and communicated back to the switch module 309.

The IFE Ad exchange module 302 might collect the passenger interaction data 303 received for all the passengers on the same flight and communicate it back to the Ad exchange platform 202 in FIG. 2 through the communication module 302. The IFE ad exchange module 302 in one embodiment might consolidate the billing and interaction data 303 received and generate the billing invoice and interaction data reports for each flight for the advertisers. In another aspect, the billing and interaction data might be handled centrally by the Ad exchange platform based on the billing and interaction data received from each one of the Ad exchange modules 302.

Other embodiments, uses and advantages of the present invention will be apparent to those skilled in the art from consideration of the specification and practices of the invention disclosed herein. The specification and examples should be considered exemplary only.

We claim:

1. An exchange based system for delivering passenger-centric advertisements through an in-flight entertainment system, the system comprising:
an advertisement campaign manager for an advertiser for providing a relevant advertisement;
an airline interface for an airline; and
an advertisement exchange platform for taking in a plurality of inputs, creating a plurality of relevant advertisements for said passenger and communicating to a plurality of aircrafts.

2. The system of claim 1, wherein the said advertisement campaign manager further comprises a mean for specifying a plurality of bids and a plurality of targeting criteria, in advance or in real-time.

3. The system of claim 1, wherein the said airline interface comprises a mean for providing passenger profile data by the airline.

4. The system of claim 2, wherein the said targeting criteria comprising:
Demographics;
Destination;
Origin;
City, state and country;

5. The system of claim 1, wherein the said advertisement exchange platform further comprising means for conducting an auction for identifying winning bids for said passenger profile data.

6. The system of claim 1, wherein the said advertisement exchange platform further comprising means for creating said plurality of relevant advertisement based on said winning bids and said plurality of targeting criteria.

7. The system of claim 1, wherein the said relevant advertisement comprising:
a video advertisement;
an audio advertisement;
a text overlay advertisement;
a display advertisement;
an in-game advertisement;
a pre-roll advertisement;
a post-roll advertisement;
an in-stream video advertisement;
an offer of buying a product or service with discount; and
a banner overlay advertisement.

8. The system of claim 1, wherein the said advertisement exchange platform further comprising a mean for generating billing information and passenger interaction data for the said advertiser.

9. The system of claim 1, wherein the said advertisement exchange platform further comprising means of communicating the said sequence of advertisements to the plurality of aircrafts.

10. A method for delivering a plurality of relevant passenger-centric advertisements to passengers comprising the steps of:
receiving the said plurality of relevant passenger-centric advertisements on-board the aircraft;
delivering the said plurality of relevant passenger-centric advertisements to an end-unit, multiplexed with the content at predetermined intervals;
collecting a passenger interaction data with the relevant advertisement; and
communicating said passenger interaction data.

11. The method of claim 10, wherein the said relevant passenger-centric advertisements comprise a sequence of relevant advertisements targeted for the passenger profile data.

12. The method of claim 10, wherein the said content comprising:
an audio media;
an interactive game;
a video media; and
an internet service.

13. The method of claim 10, wherein the said end-unit comprising:
a processor unit;
a visual display unit ;
a computer readable storage-medium;
a communication unit.

14. The method of claim 10, wherein the said communication unit receives relevant advertisements for each passenger through a wireless or wired communication link.

15. The method of claim 10, wherein the said communication unit transmits passenger interaction data through a wireless or wired communication link.

16. The method of claim 10, wherein the passenger interaction data comprising:
passenger feedback;
contact information;
billing information; and
impressions of said advertisement shown to said passenger.
